(19) United States
(12) Patent Application Publication
(10) Pub. No.: US 2020/0401191 A1
(43) Pub. Date: Dec. 24, 2020

(54) ELECTRONIC DEVICE COMPRISING CURVED GLASS

(71) Applicant: Samsung Electronics Co., Ltd., Gyeonggi-do (KR)

(72) Inventors: Myungsop LEE, Gyeonggi-do (KR); Byeongkuk LEE, Gyeonggi-do (KR); Yoonseok HWANG, Gyeonggi-do (KR)

(21) Appl. No.: 16/979,245

(22) PCT Filed: Mar. 14, 2019
(86) PCT No.: PCT/KR2019/002967

§ 371 Date: Sep. 9, 2020

(30) Foreign Application Priority Data
Mar. 14, 2018 (KR) 10-2018-0029666

(51) Int. Cl. G06F 1/16; H04M 1/02

(52) U.S. Cl. CPC G06F 1/1652; H04M 1/0268

(57) ABSTRACT

According to various embodiments, an electronic device may comprise: a housing; a glass plate attached to the housing so as to define an inner space together with the housing, the glass plate comprising a planar portion and a curved portion extending from an edge of the planar portion, the curved portion comprising a peripheral portion comprising a first surface facing the inner space in a first direction, a second surface extending form the first surface so as to face the inner space in a second direction, a third surface extending from the second surface so as to face a third direction and to be adjacent to a part of the periphery of the housing, a fourth surface extending from the third surface and facing away from the inner space in a fourth direction, and a fifth surface extending from the fourth surface and facing away from the inner surface in a fifth direction; an opaque layer formed across a part of the first surface and at least a part of the second surface; and a display arranged inside the housing and exposed to the outside through the glass plate. The electronic device described above may be varied according to embodiments.

### TECHNICAL FIELD

The disclosure relates to an electronic device. For example, the disclosure relates to an electronic device including a curved glass.

### BACKGROUND ART

As an electronic device, such as a mobile communication terminal that is carried and used by an individual user, has become popular, the appearance of the electronic device is becoming diversified and gentrified. For example, an electronic device may also be used as an ornament that is capable of revealing a user's taste or personality. Cases of electronic devices can be mass-produced at a low cost through injection molding conventionally using a synthetic resin. In order to diversify and enhance the appearances of the cases, for example, metallic materials or glass or ceramic materials are gradually being used as the exteriors of electronic devices, for example, materials for cases or housings of electronic devices.

Generally, an electronic device may include a display as one of output devices thereof, and a display panel that outputs a screen may be disposed in the housing of the electronic device in the state of being coupled to a glass plate. The glass plate may be made of tempered glass so as to ensure scratch resistance or the like. The glass plate is substantially revealed as the appearance of the electronic device, and can be used for decorating the exterior of the electronic device. For example, a portion of the outer surface of the glass plate may be formed as a curved surface. When a display (e.g., an active area) is exposed through the curved area of the glass plate, a screen output from the curved area may display content different from a screen output from another area, status information of the electronic device, or the like.

### DETAILED DESCRIPTION OF THE INVENTION

### Technical Problem

In a glass plate including a curved surface, the angled corner portion of an edge may be more likely to be exposed to an external impact when compared to a glass plate having a flat surface. When the angled corner portion of the glass plate is exposed to an external impact, the glass plate can be easily fractured. Thus, the corner portion may be processed so as to form a curved surface or a plurality of flat surfaces connected at an obtuse angle from the outer surface to the inner surface. However, in the structure in which a curved surface or a plurality of flat surfaces is connected, the structure inside the glass plate may be visually exposed to the outside due to refraction or the like.

Various embodiments are able to provide an electronic device including curved glass (e.g., a glass plate) in which damage, such as a fracture, is suppressed or mitigated, while making the exterior of the electronic device beautiful by at least partially including a curved surface.

Various embodiments are able to provide an electronic device including a curved glass, in which a corner formed by two adjacent surfaces is processed into a structure in which a curved surface or a plurality of flat surfaces are connected and an opaque layer is included in at least a portion of the edge so as to conceal an inner structure.

### Technical Solution

According to various embodiments, an electronic device may include: a housing; a glass plate attached to the housing to define an inner space with the housing and including a flat portion and a curved portion extending from an edge of the flat portion, wherein the curved portion includes an outer peripheral portion including a first surface facing the inner space in a first direction, a second surface extending from the first surface and facing the inner surface in a second direction, a third surface extending from the second surface located adjacent to a portion of an outer periphery of the housing while being oriented in a third direction, a fourth surface extending from the third surface and facing away from the inner space in a fourth direction, and a fifth surface extending from the fourth surface and facing away from the inner space in a fifth direction; an opaque layer formed on at least a portion of the first surface and at least a portion of the second surface; and a display disposed inside the housing and exposed to an outside through the first glass plate.

According to various embodiments, an electronic device may include: a glass plate including a curved portion in at least a portion of a periphery thereof; a display attached to a partial area (hereinafter, referred to as an “attachment area”) of an inner surface of the glass plate; and an opaque layer formed on at least a portion of the curved portion, wherein the glass plate may include a side end surface formed to be inclined or perpendicular to the inner surface in the curved portion and a first connection surface connecting the side end surface to the inner surface, and the opaque layer may be formed on at least the inner surface and the first connection surface around at least a portion of the attachment area.

According to various embodiments, an electronic device may include: a glass plate including an inner surface, an outer surface facing away from the inner surface, and a side end surface formed between the inner surface and the outer surface at least in at one side edge; and an opaque layer formed on a portion of the inner side surface and at least a portion of the side end surface.

### Advantageous Effects

According to various embodiments, since the glass plate disposed substantially as an exterior of an electronic device includes a curved surface at least in a portion thereof, it is possible to make the exterior of the electronic device beautiful. According to an embodiment, at least one connection surface is formed between the inner surface and the side end surface of the glass plate or between the outer surface and the side end surface of the glass plate, it is possible to alleviate or prevent damage due to interference or impact. According to another embodiment, a portion of the glass plate, for example, the side end surface may be disposed adjacent to another structure (e.g., the housing of the electronic device). Since the opaque layer is interposed between the side surface of the glass plate and the other structure, it is possible to suppress or prevent damage of the glass plate. For example, the opaque layer is able to prevent the other structure from coming into direct contact with the glass plate (e.g., the side end surface). In a still another embodiment, the opaque layer is formed around an area in which the display is disposed (e.g., an edge of the glass plate) at least on the surface facing the inner space of the electronic device, thereby blocking the exposure of an inner structure to the outside.

### BRIEF DESCRIPTION OF DRAWINGS

FIG. 1 is a perspective view illustrating the front side of an electronic device according to various embodiments;

FIG. 2 is a perspective view illustrating the rear side of the electronic device illustrated in FIG. 1;

FIG. 3 is an exploded perspective view illustrating the electronic device illustrated in FIG. 1;

FIG. 4 is a cross-sectional view illustrating a portion cut from the electronic device according to various embodiments;

FIG. 5 is a cross-sectional view illustrating a portion “E” of FIG. 4 on an enlarged scale;

FIGS. 6 and 7 are views illustrating modified examples of glass plates in an electronic device according to various embodiments; and

FIG. 8 is a flowchart for describing a method of manufacturing a glass plate in manufacturing an electronic device according to various embodiments.

### MODE FOR CARRYING OUT THE INVENTION

Embodiments of the disclosure will be described herein below with reference to the accompanying drawings. However, the embodiments of the disclosure are not limited to the specific embodiments and should be construed as including all modifications, changes, equivalent devices and methods, and/or alternative embodiments of the disclosure.

Ordinal terms such as “first” or “second” may be used to describe, not limiting, various components. These expressions are used to distinguish one component from another component. For example, a first component may be referred to as a second component, and vice versa without departing from the scope of the disclosure. The term ‘and/or’ includes one or a combination of two or more of a plurality of enumerated items.

Relative terms described with respect to what is seen in the drawings, such as “front surface,” “rear surface,” “top surface,” and “bottom surface” may substitute for ordinal numbers such as “first” and “second.” The sequence of ordinal numbers such as “first” and “second” is determined in a mentioned order or an arbitrary order, and may be changed arbitrarily when needed.

The terms as used in the disclosure are provided to merely describe specific embodiments, not intended to limit the scope of the disclosure. It is to be understood that singular forms include plural referents unless the context clearly dictates otherwise. In the disclosure, the term “include” or “have” signifies the presence of a feature, number, operation, component, part, or a combination thereof described in the disclosure, not excluding the presence of one or more other features, numbers, operations, components, parts, or a combination thereof.

Unless otherwise defined, the terms and words including technical or scientific terms used herein may have the same meanings as generally understood by those skilled in the art. The terms as generally defined in dictionaries may be interpreted as having the same or similar meanings as or to contextual meanings of related technology. Unless otherwise defined, the terms should not be interpreted as ideally or excessively formal meanings.

In the disclosure, the electronic device may be an arbitrary device including a touch panel, and the electronic device may be referred to as a terminal, a portable terminal, a mobile terminal, a communication terminal, a portable communication terminal, a portable mobile terminal, and a display device.

For example, the electronic device may be a smartphone, a portable phone, a navigation device, a gaming device, a TV, a head unit for a vehicle, a notebook computer, a laptop computer, a tablet computer, a personal media player (PMP), and a person digital assistant (PDA). The electronic device may be implemented as a portable communication terminal of a pocket size, which has a wireless communication function. Further, the electronic device may be a flexible device or a flexible display device.

The electronic device may communicate with an external electronic device, such as a server, and may perform an operation in conjunction with an external electronic device. For example, the electronic device may transmit an image captured by a camera or location information detected by a sensor unit, to a server through a network. The network is not limited thereto, but may be a mobile or cellular communication network, a local area network (LAN), a wireless local area network (WLAN), a wide area network (WAN), the internet, and a small area network (SAN).

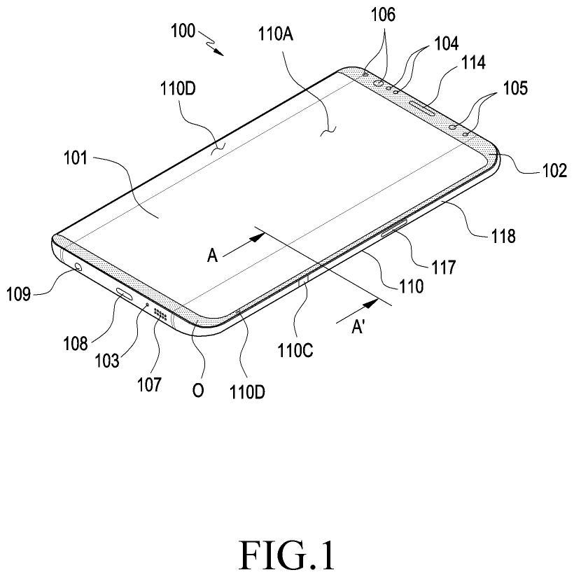

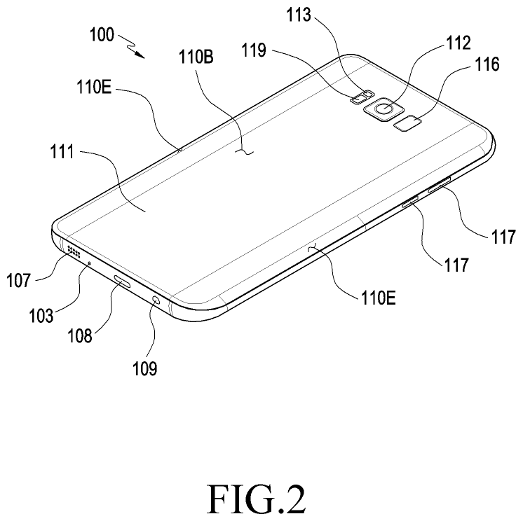

FIG. 1 is a perspective view illustrating the front side of an electronic device 100 according to various embodiments. FIG. 2 is a perspective view illustrating the rear side of the electronic device 100 illustrated in FIG. 1.

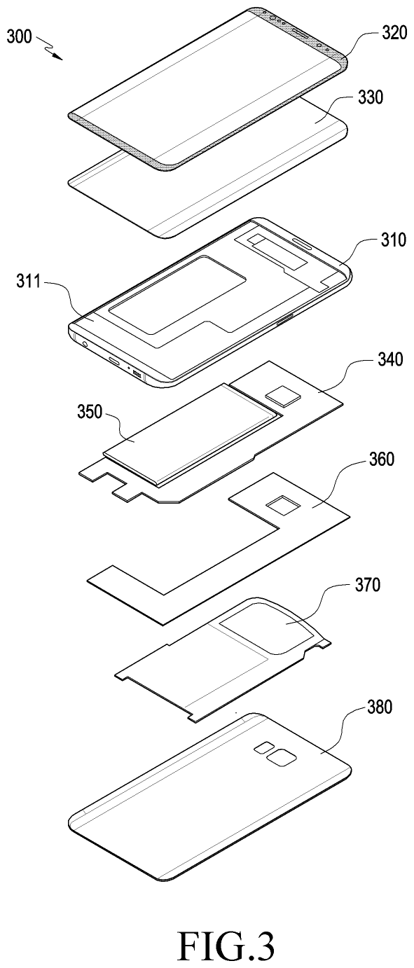

Referring to FIGS. 1 and 2, the electronic device 100 according to an embodiment may include a housing 100 including a first surface (or a front surface) 110A, a second surface (or a rear surface) 110B, and a side surface 110C surrounding the space between the first surface 110A and the second surface 110B. In another embodiment (not illustrated), the term “housing” may mean a structure forming some of the first surface 110A, the second surface 110B, and the side surface 110C of FIG. 1. According to an embodiment, at least a portion of the first surface 110A may be formed of a substantially transparent front plate 102 (e.g., a glass plate or a polymer plate including various coating layers). In another embodiment, the front plate 102 is coupled to the housing 110 so as to form an inner space with the housing 110. Here, the “inner space” may mean the space between the front plate 102 and a first support member (e.g., the first support member 311 in FIG. 3) to be described later. In various embodiments, the term “inner space” may mean the inner space of the housing 110 that accommodates at least a portion of a display 101 to be described later or the display 330 in FIG. 3.

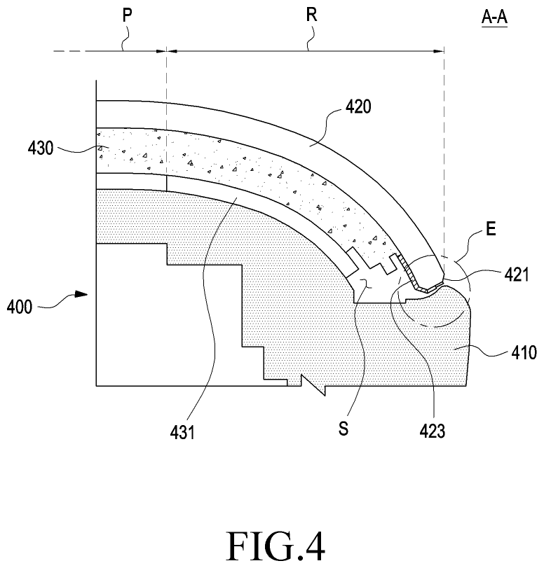

According to various embodiments, the electronic device 100 may include an opaque layer O formed in at least a portion of an edge of the front plate 102. The opaque layer (O) may be made of, for example, a printing layer or a film layer containing a pigment or dye. In an embodiment, the opaque layer (O) may be formed around the area in which the display 101 is attached, on the inner surface of the front plate 102. For example, the opaque layer O may be formed to form a closed curve surrounding a portion of the inner surface of the front plate 102. In various embodiments, the opaque layer (O) may be a polymeric layer attached to the inner surface of the front plate 102, and may be disposed adjacent to a light-emitting layer, a polarizing plate, a touch panel, or the like included as a portion of the display 101. The configuration of the opaque layer will be described in more detail with reference to, for example, FIG. 4.

According to various embodiments, the second surface 110B may be formed by a substantially opaque rear plate 111. The rear plate 111 may be formed of, for example, coated or colored glass, ceramic, polymer, metal (e.g., aluminum, stainless steel (STS), or magnesium), or a combination of two or more of these materials. The side surface 110C may be formed by a side bezel structure 118 (or a “side member”) coupled to the front plate 102 and the rear plate 111 and including a metal and/or a polymer. In various embodiments, the rear plate 111 and the side bezel structure 118 may be integrally formed, and may include the same material (e.g., a metal material such as aluminum).

In the illustrated embodiment, the front plate 102 may include two first areas 110D (e.g., the curved portions R in FIG. 4), which are bent from the first surface 110A toward the rear plate 111 and extend seamlessly, at the long opposite side edges thereof. In the illustrated embodiment (see FIG. 2), the rear plate 111 may include, at the long opposite side edges thereof, two second areas 110E, which are bent from the second surface 110B toward the front plate 102 and extend seamlessly. In various embodiments, the front plate 102 (or the rear plate 111) may include only one of the first areas 110D (or the second areas 110E). In another embodiment, some of the first areas 110D or the second areas 110E may not be included. In the embodiments described above, when viewed from a side of the electronic device 100, the side bezel structure 118 may have a first thickness (or width) on the side surface in which the first areas 110D or the second areas 110E are not included (e.g., the side surface in which the connector hole 108 is formed), and may have a second thickness, which is smaller than the first thickness, on the side surface in which the first areas 110D or the second areas 110E are included (e.g., the side surface in which the key input device 117 is disposed).

According to an embodiment, the electronic device 100 may include at least one of a display 101, audio modules 103, 107, and 114, sensor modules 104, 116, and 119, camera modules 105, 112, and 113, key input devices 117, light-emitting elements 106, and connector holes 108 and 109. In various embodiments, at least one of the components (e.g., the key input devices 117 or the light-emitting elements 106) may be omitted from the electronic device 100, or the electronic device 100 may additionally include other components.

The display 101 may be exposed through, for example, a substantial portion of the front plate 102. In various embodiments, at least a portion of the display 101 may be exposed through the front plate 102 forming the first surface 110A and the first areas 110D of the side surface 110C. In various embodiments, the edges of the display 101 may be formed to be substantially the same as the shape of the periphery of the front plate 102 adjacent thereto. In another embodiment (not illustrated), the distance between the periphery of the display 101 and the periphery of the front plate 102 may be substantially constant in order to enlarge the exposed area of the display 101.

In another embodiment (not illustrated), a recess or an opening may be formed in a portion of a screen display area (e.g., an active area) or an area (e.g., a non-active area) out of the screen display area of the display 101, and at least one of the audio module 114, the sensor module 104, the camera module 105, and the light-emitting element 106, which are aligned with the recess or the opening, may be included. In another embodiment (not illustrated), the rear surface of the screen display area of the display 101 may include at least one of the audio module 114, the sensor module 104, the camera module 105, the fingerprint sensor 116, and the light-emitting elements 106. In another embodiment (not illustrated), the display 101 may be coupled to or disposed adjacent to a touch-sensitive circuit, a pressure sensor that is capable of measuring a touch intensity (pressure), and/or a digitizer that detects a magnetic-field-type stylus pen. In some embodiments, at least some of the sensor modules 104 and 119 and/or at least some of the key input devices 117 may be disposed in the first areas 110D and/or the second areas 110E.

The audio modules 103, 107, and 114 may include a microphone hole 103 and speaker holes 107 and 114. The microphone hole 103 may include a microphone disposed therein so as to acquire external sound, and in various embodiments, multiple microphones may be disposed therein so as to detect the direction of sound. The speaker holes 107 and 114 may include an external speaker hole 107 and a phone call receiver hole 114. In some embodiments, the speaker holes 107 and 114 and the microphone hole 103 may be implemented as a single hole, or a speaker (e.g., a piezo speaker) may be included without the speaker holes 107 and 114.

The sensor modules 104, 116, and 119 may generate electrical signals or data values corresponding to the internal operating state or the external environmental state of the electronic device 100. The sensor modules 104, 116, and 119 may include, for example, a first sensor module 104 (e.g., a proximity sensor) and/or a second sensor module (not illustrated) (e.g., a fingerprint sensor) disposed on the first surface 110A of the housing 110, and/or a third sensor module 119 (e.g., an HRM sensor) and/or a fourth sensor module 116 (e.g., a fingerprint sensor) disposed on the second surface 110B of the housing 110. The fingerprint sensor may be disposed not only on the first surface 110A (e.g., the display 101) of the housing 110, but also on the second surface 110B. The electronic device 100 may further include at least one of sensor modules (not illustrated), such as a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor 104.

The camera modules 105, 112, and 113 may include a first camera device 105 disposed on the first surface 110A of the electronic device 100, a second camera device 112 disposed on the second surface 110B, and/or a flash 113. The camera devices 105 and 112 may include one or more lenses, an image sensor, and/or an image signal processor. The flash 113 may include, for example, a light-emitting diode or a xenon lamp. In various embodiments, two or more lenses (e.g., an infrared camera lens, a wide-angle lens, and a telephoto lens) and image sensors may be disposed on one surface of the electronic device 100.

The key input devices 117 may be disposed on the side surface 110C of the housing 110. In another embodiment, the electronic device 100 may not include some or all of the above-mentioned key input devices 117, and a key input device 117, which is not included therein, may be implemented in another form of a soft key or the like on the display 101. In some embodiments, the key input devices may include a sensor module 116 disposed on the second surface 110B of the housing 110.

The light-emitting element 106 may be disposed, for example, on the first surface 110A of the housing 110. The light-emitting element 106 may provide, for example, information about the state of the electronic device 100 in an optical form. In another embodiment, the light-emitting element 106 may provide a light source that is interlocked with, for example, the operation of the camera module 105. The light-emitting element 106 may include, for example, an LED, an IR LED, and a xenon lamp.

The connector holes 108 and 109 may include a first connector hole 108 that is capable of accommodating a connector (e.g., a USB connector) for transmitting and receiving power and/or data to and from an external electronic device, and/or a second connector hole 109 that is capable of accommodating a connector (e.g., an earphone jack) for transmitting and receiving an audio signal to and from an external electronic device.

FIG. 3 is an exploded perspective view illustrating the electronic device illustrated in FIG. 1.

Referring to FIG. 3, an electronic device 300 may include a side bezel structure 310, a first support member 311 (e.g., a bracket), a front plate 320, a display 330, a printed circuit board 340, a battery 350, a second support member 360 (e.g., a rear case), an antenna 370, and a rear plate 380. In various embodiments, in the electronic device 300, at least one of the components (e.g., the first support member 311 or the second support member 360) may be omitted, or other components may be additionally included. At least one of the components of the electronic device 300 may be the same as or similar to at least one of the components of the electronic device 100 of FIG. 1 or 2, and a redundant description thereof is omitted below.

The first support member 311 may be disposed inside the electronic device 300, and may be connected to the side bezel structure 310 or may be integrally formed with the side bezel structure 310. The first support member 311 may be formed of, for example, a metal material and/or a non-metal material (e.g., a polymer). The display 330 may be coupled to one surface of the first support member 311, and the printed circuit board 340 may be coupled to the other surface of the first support member 311. On the printed circuit board 340, a processor, a memory, and/or an interface may be mounted. The processor may include at least one of, for example, a central processing unit, an application processor, a graphics processor, an image signal processor, a sensor hub processor, or a communication processor.

The display 330 may have a substantially entire area attached to the inner surface of the front plate 320, and an opaque layer (e.g., the opaque layer O in FIG. 1) may be formed in the periphery of or around the area in which the display 330 is attached) on the inner surface of the front plate 320. In the area of the front plate 320 in which the display 330 is not disposed, such an opaque layer may block the exposure of a portion of an inner structure (e.g., the first support member 311) of the electronic device 300 to the outside.

The memory may include, for example, a volatile memory or a nonvolatile memory.

The interface may include, for example, a high-definition multimedia interface (HDMI), a universal serial bus (USB) interface, an SD card interface, and/or an audio interface. The interface may electrically or physically connect, for example, the electronic device 300, to an external electronic device, and may include a USB connector, an SD card/an MMC connector, or an audio connector.

The battery 350 is a device for supplying power to at least one component of the electronic device 300, and may include, for example, a non-rechargeable primary battery, a rechargeable secondary battery, or a fuel cell. At least a portion of the battery 350 may be disposed on substantially the same plane as, for example, the printed circuit board 340. The battery 350 may be integrally disposed inside the electronic device 300, or may be detachably disposed on the electronic device 300.

The antenna 370 may be disposed between the rear plate 380 and the battery 350. The antenna 370 may include, for example, a nearfield communication (NFC) antenna, a wireless charging antenna, and/or a magnetic secure transmission (MST) antenna. The antenna 370 is capable of, for example, performing short-range communication with an external device or transmitting and receiving power required for charging to and from an external device in a wireless manner. In another embodiment, an antenna structure may be formed by the side bezel structure 310 and/or a portion of the first support member 311, or a combination thereof.

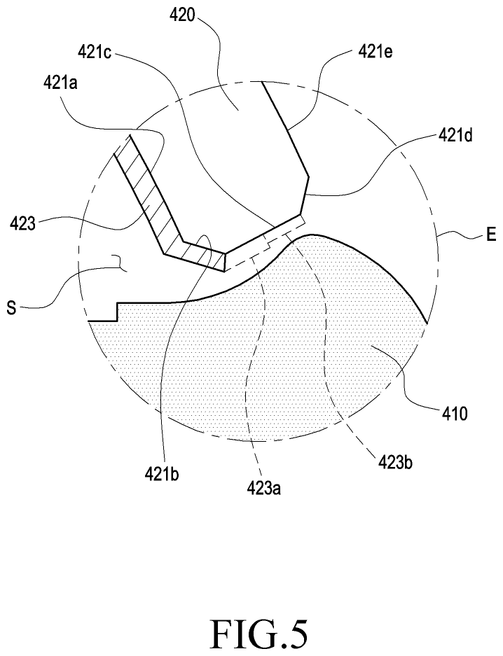

FIG. 4 is a cross-sectional view illustrating a portion cut from the electronic device 400 according to various embodiments of the disclosure. FIG. 5 is a cross-sectional view illustrating a portion “E” of FIG. 4 on an enlarged scale. FIG. 4 may be a view illustrating a cross section taken along line A-A in FIG. 1.

Referring to FIGS. 4 and 5, an electronic device 400 (e.g., the electronic device 100 or 300 in FIG. 1 or FIG. 3) includes a glass plate 420 (e.g., the front plate 320 in FIG. 3), a display 430 attached to the inner surface of the glass plate 420 (e.g., the display 330 in FIG. 3), an opaque layer 423 formed on the inner surface of the glass plate 420 (e.g., the opaque layer O in FIG. 1). According to an embodiment, the glass plate 420 is coupled to the housing 410 (e.g., the side bezel structure 310 or the first support member 311 of FIG. 3) so as to form an inner space S that at least partially accommodates the display 430. The electronic device 400 may further include an adhesive member 431 (e.g., double-sided tape), thereby coupling the glass plate 420 with the housing 410. In an embodiment, the glass plate 420 may be coupled to the housing 410 by attaching the display 430 to the housing 410 using the adhesive member 431. In another embodiment, by using the adhesive member 431, a portion of the display 430 may be attached to the housing 410 in an area corresponding to the curved portion R of the glass plate 420.

According to various embodiments, the glass plate 420 may include a flat portion P and a curved portion R extending from an edge of the flat portion P (e.g., the first area 110D in FIG. 1). The display 430 is generally disposed to correspond to the flat portion P, but a portion of the edge may be disposed to correspond to the curved portion R. In various embodiments, the display 430 may output a screen corresponding to an application that is currently being executed in an area corresponding to the flat portion P, and other content in an area corresponding to the curved portion R. For example, in an area corresponding to the curved portion R, the display 430 may display a task bar, a clock, an application execution icon according to a user's setting, and information related to a received call or message. In an area corresponding to the curved portion R, information, icons, or the like displayed by the display 430 may vary according to the user's setting.

According to various embodiments, the glass plate 420 may include an outer peripheral portion 421 that is disposed substantially adjacent to the housing 410 when the glass plate 420 is coupled to the housing 410. The outer peripheral portion 421 may mean, for example, a portion of the curved portion R, and in various embodiments, the outer peripheral portion R may be substantially an edge or a rim of the glass plate 420. According to an embodiment, the outer peripheral portion 421 may include a first surface 421a, a second surface 421b, a third surface 421c, a fourth surface 421d, or a fifth surface 421e arranged sequentially to connect the outer surface to the inner surface of the glass plate 420 (or the curved portion R).

According to various embodiments, the first surface 421a is a surface substantially facing the inner space S in a first direction, and may be at least a portion of the inner surface of the glass plate 420. The second surface 421b is a surface substantially extending from the first surface 421a and facing the inner space S in a second direction different from the first direction, and may be another portion of the inner surface of the glass plate 420. The third surface 421c extends from the second surface 421b, and may be formed to face a third direction different from the first direction or the second direction. In an embodiment, the third surface 421c may be at least portion of a side end surface of the glass plate 420. For example, if the third surface 421c is formed on a plate-shaped plate, the third surface 421c may be disposed to be substantially perpendicular to the inner or outer surface of the plate-shaped plate. The fourth surface 421d extends from the third surface 421c and may be formed to face the outside of the electronic device 400 in a fourth direction different from the first to third directions. The fifth surface 421e extends from the fourth surface 421d, and may be formed to face the outside of the electronic device 400 in a fifth direction substantially opposite the first direction. In various embodiments, the fifth surface 421e may be a portion of the outer surface of the glass plate 420 or the curved portion R.

According to various embodiments, the third surface 421c may be substantially formed (disposed) as a side end surface of the glass plate 420 to be inclined or perpendicular to the inner or outer surface of the glass plate 420. For example, the third surface 421c is one surface of the curved portion R or the outer peripheral portion 421, and the inclined angle of the third surface 421c to the inner or outer surface of the glass plate 420 may vary. In an embodiment, when the glass plate 420 is coupled to the housing 410, the third surface 421c (or the side end surface of the glass plate 420) may be disposed to be least partially adjacent to or to face a portion of the housing 410. In various embodiments, the glass plate 420 may be coupled to substantially face the housing 410 so as to form a space in which the display 430 is capable of being accommodated or disposed (e.g., the inner space S). In an embodiment of the disclosure, the wording “the third surface is disposed adjacent to a portion of the housing” means that the third surface 421c is disposed closer to the housing 410 than other portions of the glass plate 420.

According to various embodiments, the second surface 421b is a connection surface connecting the inner surface (e.g., the first surface 421a) of the glass plate 420 to the side end surface (e.g., the third surface 421c), and may include an inclined surface formed to be inclined with respect to the first surface 421a or the third surface 421c. According to an embodiment, the second surface 421b may increase the angle between two surfaces forming a corner at an edge of the glass plate 420. For example, when the second surface 421b is not formed, and the first surface 421a and the third surface 421c meet to form a corner, the third surface 421c may be disposed to form an angle of about 90 degrees with respect to the first surface 421a at the corner. The second surface 421b is formed to be inclined with respect to the first surface 421a and the third surface 421c while connecting the first surface 421a and the third surface 421c to each other, whereby two surfaces (e.g., the first surface 421a and the second surface 421b or the second surface 421b and the third surface 421c) may be disposed to form an obtuse angle at each of the corner formed by the first surface 421a and the second surface 421b or the corner formed by the second surface 421b and the third surface 421c. In various embodiments, when two surfaces form a corner, as the angle formed by the two surfaces is reduced, the corner may be more easily damaged by interference or impact. According to various embodiments, the second surface 421b increases the angle between the two surfaces forming the corner, whereby damage to the glass plate 420 due to interference or impact at the corner of the glass plate 420 can be alleviated or prevented.

According to various embodiments, similar to the second surface 421b, the fourth surface 421d may include another connection surface formed between the third surface 421c and the fifth surface 421e (e.g., a surface connecting the third surface 421c and the fifth surface 421e). In an embodiment, the fourth surface 421d increases the angle between two surfaces forming a corner (e.g., the third surface 421c and the fourth surface 421d or the fourth surface 421d and the fifth surface 421e), whereby damage at the corner of the glass plate 420 can be alleviated and prevented.

According to various embodiments, the display 430 may include at least one polymer layer. For example, when the display 430 includes a touch screen function, the display 430 may include a touch panel (or a polyimide film having a transparent electrode for touch sensing) disposed to be substantially in contact with the glass plate 420. In various embodiments, such a polymer layer may include a light-emitting layer. In another embodiment, the polymer layer may include an encapsulation layer(s) that seals the light-emitting layer. In another embodiment, the polymer layer may include a polarizing plate disposed on the front surface or the rear surface of the light-emitting layer. For example, the display 430 may essentially consist of a polymer layer, or at least partially include a polymer layer.

According to various embodiments, the opaque layer 423 may include a printing layer or a film layer, and may be formed in a portion of the inner surface of the glass plate 420 (e.g., a portion of the first surface 421a and/or at least a portion of the second surface 421b). In various embodiments, the opaque layer 423 may be further formed on the outer peripheral portion 421, for example, the third surface 421c. According to an embodiment, the opaque layer 423 may be formed substantially along the periphery of the area to which the display 430 is attached. For example, the opaque layer 423 may block the penetration of light through the glass plate 420 in an area in which the display 430 is not attached. In various embodiments, when the glass plate 420 is coupled to the housing 410, the opaque layer 423 may block the visual exposure of the internal space S to the outside.

According to various embodiments, the opaque layer 423 is, for example, a printing layer containing a pigment or dye, and may be formed through a method such as vapor deposition, painting using a roller or a dispenser, press printing, or screen printing. In another embodiment, the opaque layer 423 may include, for example, an opaque film layer, and the film layer may be laminated to the glass plate 420 using a roller, a vacuum pump, an air blower, or the like so as to form the opaque layer 423. In another embodiment, the opaque layer 423 may include a film layer laminated to the glass plate 420 and a printing layer formed on the film layer. In various embodiments, when the opaque layer 423 includes a film layer, the film layer may be transparently formed in an area in which the display 430 is attached.

According to various embodiments, the opaque layer 423 may be interposed between the third surface 421c and the housing 410. For example, the opaque layer 423 may be further formed on the third surface 421c in an area indicated by reference numeral “423a” or an area indicated by reference numeral “423b”, and may prevent the glass plate 420 (or the third surface 421c) from coming into direct contact with the housing 410. In an embodiment, the opaque layer 423 is able to prevent a glass material (e.g., the glass plate 420) from coming into direct contact with another structure (e.g., the housing 410 or a metal portion of the side bezel structure 118 in FIG. 1), and to prevent an impact from being directly transmitted to the glass plate 420 when an external impact is applied to the housing 410. In various embodiments, when a fracture or a crack has already occurred in the glass plate 420, the opaque layer 423 may suppress diffusion of the fracture or the crack. For example, even if a fracture or a crack has already occurred, it is possible to prevent the damage from increasing due to partial separation or the like from the glass plate 420.

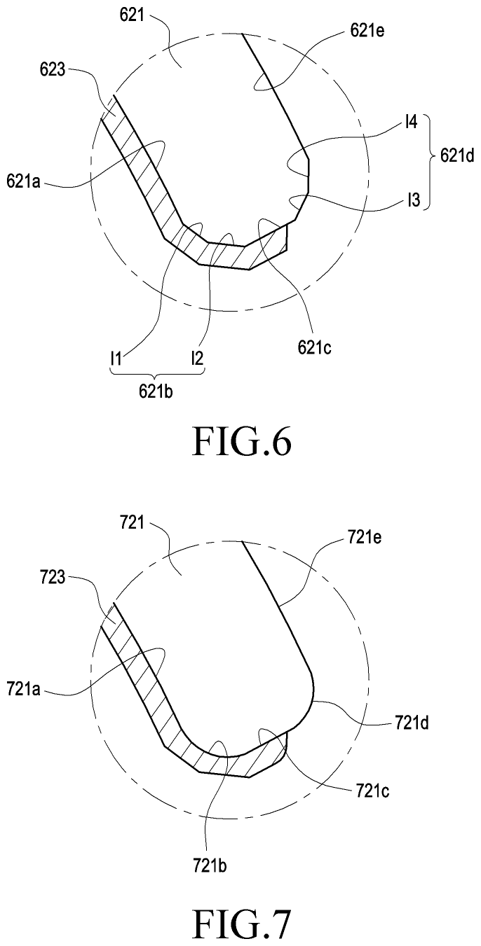

FIGS. 6 and 7 are views illustrating modified examples of glass plates in an electronic device according to various embodiments of the disclosure.

Referring to FIG. 6, a glass plate of an electronic device according to various embodiments may include a connection surface(s) including a plurality of inclined surfaces. For example, an outer peripheral portion 621 of a glass plate (e.g., the glass plate 420 in FIG. 4) may substantially include a first surface 621a which is a portion of the inner surface of the glass plate, a third surface 621c which is a portion of a side end surface of the glass plate, a fifth surface 621e which is a portion of the outer surface of the glass plate, a second surface 621b connecting the third surface 621c to the first surface 621a between the first surface 621a and the third surface 621c, and a fourth surface 621d connecting the third surface 621c to the fifth surface 621e between the third surface 621c and the fifth surface 621e. For example, the second surface 621b and the fourth surface 621d may be provided as connection surfaces connecting the third surface 621c to the inner surface (e.g., the first surface 621a) or the outer surface (e.g., the fifth surface 621e).

According to various embodiments, the second surface 621b may include a plurality of inclined surfaces I1 and I2 extending obliquely with respect to each other. In another embodiment, the fourth surface 621d may include a plurality of other inclined surfaces I3 and I4 extending obliquely with respect to each other. For example, a plurality of inclined surfaces I1, I2, I3, and I4 may be combined so as to form a surface(s) (e.g., the second surface 621b and the fourth surface 621d) connecting the first surface 621a and the third surface 621c (or the third surface 621c and the fifth surface 621e). Since the connection surfaces (e.g., the second surface 621b and the fourth surface 621d) are formed by a combination of inclined surfaces, an angle between two surfaces forming the corner at the outer peripheral portion 621 can be increased. As described above, by increasing the angle between the two surfaces forming the corner, it is possible to suppress or prevent damage to the glass plate (e.g., the corner(s) formed at the outer peripheral portion 621) due to interference or impact.

According to various embodiments, the number of inclined surfaces combined to form connection surfaces (e.g., the second surface 621b and the fourth surface 621d) may be increased. For example, the second surface 621b may be formed by combining three or four inclined surfaces. As the number of inclined surfaces forming one connection surface increases, the connection surface (e.g., the second surface 621b or the fourth surface 621d) may have a shape close to a curved surface.

In an embodiment, an opaque layer 623 may be formed on the outer peripheral portion 621. For example, the opaque layer 623 may be formed on a portion of the first surface 621a, at least a portion (or whole) of the second surface 621b, or at least a portion of the third surface 621c. The opaque layer 623 may block the penetration of light through a glass plate, for example, at least a portion of the outer peripheral portion 621. In various embodiments, when the third surface 621c is disposed to be adjacent or to face a portion of another structure (e.g., the housing 410 in FIG. 5), the opaque layer 623 is able to prevent the third surface 621c from coming into direct contact with another structure.

Referring to FIG. 7, a glass plate of an electronic device according to various embodiments may include a connection surface(s) forming a curved surface. For example, an outer peripheral portion 721 of a glass plate (e.g., the glass plate 420 in FIG. 4) may substantially include a first surface 721a which is a portion of the inner surface of the glass plate, a third surface 721c which is a portion of a side end surface of the glass plate, a fifth surface 721e which is a portion of the outer surface of the glass plate, a second surface 721b connecting the third surface 721c to the first surface 721a between the first surface 721a and the third surface 721c, and a fourth surface 721d connecting the third surface 721c to the fifth surface 721e. For example, the second surface 721b and the fourth surface 721d may be provided as connection surfaces connecting the third surface 721c to the inner surface (e.g., the first surface 721a) or the outer surface (e.g., the fifth surface 721e).

According to various embodiments, each of the second surface 721b and the fourth surface 721d may be curved, and substantially no corner may be formed. For example, since the connection surface is formed as a curved surface, it is possible to suppress and prevent damage that may occur at the corner due to interference or impact with another structure.

According to various embodiments, an opaque layer 723 may be formed on the outer peripheral portion 721. For example, the opaque layer 723 may be formed on a portion of the first surface 721a, at least a portion of the second surface 721b, or at least a portion of the third surface 721c. The opaque layer 723 may block the penetration of light through a glass plate, for example, at least a portion of the outer peripheral portion 721. In various embodiments, when the third surface 721c is disposed to be adjacent or to face a portion of another structure (e.g., the housing 410 in FIG. 5), the opaque layer 723 is able to prevent the third surface 721c from coming into direct contact with another structure. For example, the opaque layer 723 is able to prevent the third surface 721c (or the glass plate 420 in FIG. 4) from coming into direct contact with another structure, and to alleviate an impact or the like transmitted through the another structure.

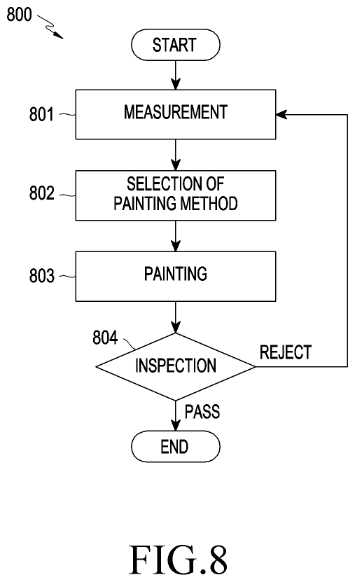

FIG. 8 is a flowchart for describing a method of manufacturing a glass plate 800 in manufacturing an electronic device according to various embodiments. In explaining the method 800, FIGS. 4 and 5 will be further referred to.

Referring to FIG. 8, the method of manufacturing a glass plate 800 may include a measurement operation 801, a selection operation 802, a painting operation 803, and an inspection operation 804.

According to various embodiments, the measurement operation 801 is an operation of measuring the width of an area to form the opaque layer 423 or the like in the periphery of the manufactured glass plate 420, for example, the outer peripheral portion 421. For example, the width of an area to which the display 430 is not attached on the first surface 421a may be measured. In various embodiments, in the measurement operation 801, the width of an area to form the opaque layer 423 on the second surface 421b may be measured. In another embodiment, the opaque layer 423 may also be formed on the third surface 421c, the fourth surface 421d, and the fifth surface 421e, and in the measurement operation 801, an area to form the opaque layer 423 on the corresponding surface may be measured. In an embodiment, the measurement operation 801 may be performed in a step of inspecting the quality of a manufactured glass plate.

According to various embodiments, the selection operation 802 is an operation of selecting a painting method for forming an opaque layer 423, and the painting method may be determined in consideration of the measurement results in the measurement operation (801) and the appearance (e.g., a design, a color, or a texture) of an electronic device 400 to be equipped with an object to be painted (e.g., the glass plate 420). In various embodiments, in the selection operation 802, a paint, an adhesive component for laminating, or the like in consideration of surface characteristics (e.g., affinity with a paint) of the glass plate 420 may be determined, and the painting method may be selected in consideration of the type of the selected paint or adhesive component. In this embodiment, the term “painting” is used, but the disclosure is not limited thereto. For example, the “painting” may generally mean a method of applying, printing, or spraying a paint containing a pigment or dye, but the opaque layer 423 according to various embodiments may be formed by laminating a film layer printed with a desired pattern or a dyed film layer to the glass plate 420. Examples of the painting method may include a coating method using a roller, a spray method, an engraving printing method, and a lamination method.

According to various embodiments, the painting operation 803 is an operation of forming an opaque layer using a selected painting method. As described above, the opaque layer 423 may be formed in the area measured in the measurement operation (801) through a coating method using a roller or a dispenser, a spraying method, an engraving printing method, or a lamination method. According to an embodiment, after forming a portion of the opaque layer 423 through a lamination method, the opaque layer 423 may be completed through additional coating or printing. For example, the color, transmittance, or the like of the opaque layer 423 may be adjusted by additionally applying a paint to complete the opaque layer 423. As described above with reference to various embodiments, the opaque layer 423 may be further formed on a portion of the first surface 421a, at least a portion of the second surface 421b, and at least a portion of the third surface 421c. According to an embodiment, when the third surface 421c is disposed adjacent to another structure (e.g., the housing 410), the opaque layer 423 is able to prevent the third surface 421c from coming into direct contact with the other structure, and is able to alleviate or block an impact applied to the glass plate 420 or the third surface 421c from another structure.

According to various embodiments, the inspection operation 804 is an operation of determining whether the opaque layer 423 is formed in an appropriate area and thickness. In the inspection operation 804, it is possible to determine whether or not the opaque layer is defective according to preset criteria. Here, the “preset criteria” may include reference values for the thickness and tolerance of the opaque layer 423, and an area or transmittance required to block the penetration of light through the glass plate 420 in the area in which the display 430 is not attached. In one embodiment, the glass plate (e.g., the glass plate 420 on which the opaque layer is formed) determined to be defective in the inspection operation 804 may be painted again according to the method described above from the measurement operation 801. In various embodiments, when the opaque layer does not reach the designed area and thickness and is determined to be defective in the inspection result, additional painting may be performed. In another embodiment, when the opaque layer is formed in excess of the designed area or thickness and is determined to be defective in the inspection result, the opaque layer that has already been formed may be removed before resuming the measurement operation 801.

As described above, according to various embodiments, an electronic device (e.g., the electronic device 300 or 400 in FIG. 3 or FIG. 4) may include: a housing (e.g., the housing 410 in FIG. 4); a glass plate (e.g., the glass plate 320 in FIG. 3 or the glass plate 420 in FIG. 40) attached to the housing to define an inner space with the housing and including a flat portion (e.g., the flat portion P in FIG. 4) and a curved portion (e.g., the curved portion R in FIG. 4) extending from an edge of the flat portion, wherein the curved portion (e.g., the curved portion R in FIG. 4) may include an outer peripheral portion (e.g., the outer peripheral portion 421 in FIG. 4) including a first surface (e.g., the first surface 421a in FIG. 5) facing the inner space (e.g., the inner face S in FIG. 5) in a first direction, a second surface (e.g., the second surface 421b in FIG. 5) extending from the first surface and facing the inner surface in a second direction, a third surface (e.g., the third surface 421c in FIG. 5) extending from the second surface located adjacent to a portion of an outer periphery of the housing while being oriented in a third direction, a fourth surface (e.g., the fourth surface 421d in FIG. 5) extending from the third surface and facing away from the inner space in a fourth direction, and a fifth surface (e.g., the fifth surface 421e in FIG. 5) extending from the fourth surface and facing away from the inner space in a fifth direction; an opaque layer (e.g., the opaque layer 423 in FIG. 5) formed on at least a portion of the first surface and at least a portion of the second surface; and a display (e.g., the display 430 in FIG. 4) disposed inside the housing and exposed to an outside through the first glass plate.

According to various embodiments, the opaque layer may be further formed on at least a portion of the third surface.

According to various embodiments, the opaque layer may contain a pigment or dye.

According to various embodiments, the electronic device may further include a polymeric layer (e.g., the display 430 in FIG. 4) attached on another portion of the first surface to be adjacent to one side of the opaque layer.

According to various embodiments, an electronic device may include: a glass plate including a curved portion in at least a portion of a periphery thereof; a display attached to a partial area (hereinafter, referred to as an “attachment area”) of an inner surface of the glass plate; and an opaque layer formed on at least a portion of the curved portion, wherein the glass plate may include a side end surface (e.g., the third surface 421c in FIG. 5) formed to be inclined or perpendicular to the inner surface in the curved portion and a first connection surface (e.g., the second surface 421b in FIG. 5) connecting the side end surface to the inner surface, and the opaque layer may be formed on at least the inner surface and the first connection surface around at least a portion of the attachment area.

According to various embodiments, the opaque layer may be further formed on at least a portion of the side end surface.

According to various embodiments, the first connection surface may be formed to be inclined with respect to the inner surface or the side end surface.

According to various embodiments, the first connection surface may include a plurality of inclined surfaces (e.g., the inclined surfaces I1 and I2 in FIG. 6), each of which is formed to be inclined with respect to the inner surface, and the plurality of inclined surfaces may be formed to be inclined with respect to each other.

According to various embodiments, the first connection surface may include a curved surface (e.g., the second surface 721b in FIG. 7).

According to various embodiments, the electronic device may further include a housing coupled to the glass plate so as to define an inner space with the glass plate, wherein at least a portion of the side end surface may be formed to face a portion of the housing.

According to various embodiments, the opaque layer may be interposed between the at least a portion of the side end surface and the portion of the housing.

According to various embodiments, a portion of the display may be attached to the housing in an area corresponding to the curved portion.

According to various embodiments, the display may be partially attached to the curved portion and may be disposed to be adjacent to the opaque layer.

According to various embodiments, the glass plate may further include an outer surface (e.g., the fifth surface 421e in FIG. 5) facing away from the inner surface in the curved portion and a second connection surface (e.g., the fourth surface 421d in FIG. 5) connecting the outer surface to the side end surface.

According to various embodiments, the second connection surface may include at least one inclined surface formed to be inclined with respect to a curved surface or the side end surface.

According to various embodiments, the opaque layer may include a printed layer or a film layer.

According to various embodiments, an electronic device may include: a glass plate including an inner surface, an outer surface facing away from the inner surface, and a side end surface formed between the inner surface and the outer surface at least in at one side edge; and an opaque layer formed on a portion of the inner side surface and at least a portion of the side end surface.

According to various embodiments, the glass plate may further include a connection surface formed to connect the inner surface and the side end surface, and a portion of the opaque layer may be formed on the connection surface.

According to various embodiments, the connection surface may include an inclined surface formed to be inclined with respect to a curved surface or the side end surface.

According to various embodiments, the connection surface may include a plurality of inclined surfaces formed to be inclined with respect each other.

In the foregoing detailed description, specific embodiments of the disclosure have been described. However, it will be evident to a person ordinarily skilled in the art that various modifications may be made without departing from the scope of the disclosure.

For example, various embodiments of the disclosure exemplify a configuration in which an opaque layer or a printed layer is formed on the inner surface and/or the side end surface of the glass plate. However, the opaque layer or the printed layer may be formed on the outer surface of the glass plate and/or a connection surface between the outer surface and the side end surface. In an embodiment, the opaque layer or the printed layer may substantially enclose an edge of the glass plate, thereby protecting the glass plate.

1. An electronic device comprising:
a housing;
a glass plate attached to the housing to define an inner space with the housing and comprising a flat portion and a curved portion extending from an edge of the flat portion, wherein the curved portion includes an outer peripheral portion including a first surface facing the inner space in a first direction, a second surface extending from the first surface and facing the inner surface in a second direction, a third surface extending from the second surface located adjacent to a portion of an outer periphery of the housing while being oriented in a third direction, a fourth surface extending from the third surface and facing away from the inner space in a fourth direction, and a fifth surface extending from the fourth surface and facing away from the inner space in a fifth direction;
an opaque layer formed on at least a portion of the first surface and at least a portion of the second surface; and
a display disposed inside the housing and exposed to an outside through the first glass plate.

2. The electronic device of claim 1, wherein the opaque layer is further formed on at least a portion of the third surface.

3. The electronic device of claim 2, wherein the opaque layer contains a pigment or dye.

4. The electronic device of claim 1, further comprising:
a polymeric layer attached on another portion of the first surface to be adjacent to one side of the opaque layer.

5. An electronic device comprising:
a glass plate comprising a curved portion in at least a portion of a periphery thereof;
a display attached to a partial area (hereinafter, referred to as an “attachment area”) of an inner surface of the glass plate; and
an opaque layer formed on at least a portion of the curved portion,
wherein the glass plate comprises a side end surface formed to be inclined or perpendicular to the inner surface in the curved portion and a first connection surface connecting the side end surface to the inner surface, and
the opaque layer is formed on at least the inner surface and the first connection surface around at least a portion of the attachment area.

6. The electronic device of claim 5, wherein the opaque layer is further formed on at least a portion of the side end surface.

7. The electronic device of claim 5, wherein the first connection surface is formed to be inclined with respect to the inner surface or the side end surface.

8. The electronic device of claim 5, wherein the first connection surface comprises a plurality of inclined surfaces each of which is formed to be inclined with respect to the inner surface, and
the plurality of inclined surfaces are formed to be inclined with respect to each other.

9. The electronic device of claim 5, wherein the first connection surface comprises a curved surface.

10. The electronic device of claim 5, further comprising:
a housing coupled to the glass plate so as to define an inner space with the glass plate,
wherein at least a portion of the side end surface is formed to face a portion of the housing.

11. The electronic device of claim 10, wherein the opaque layer is interposed between the at least a portion of the side end surface and the portion of the housing.

12. The electronic device of claim 10, wherein a portion of the display is attached to the housing in an area corresponding to the curved portion.

13. The electronic device of claim 5, wherein the display is partially attached to the curved portion and is disposed to be adjacent to the opaque layer.

14. The electronic device of claim 5, wherein the glass plate further comprises an outer surface facing away from the inner surface in the curved portion and a second connection surface connecting the outer surface to the side end surface.

15. The electronic device of claim 14, wherein the second connection surface includes at least one inclined surface formed to be inclined with respect to a curved surface or the side end surface.
